(19) United States
(12) Patent Application Publication
(10) Pub. No.: US 2016/0092828 A1
(43) Pub. Date: Mar. 31, 2016

(54) System and Method for Taking Inventory and Ordering

(71) Applicant: Paul Sofsky, Sherman Oaks, CA (US)

(72) Inventor: Paul Sofsky, Sherman Oaks, CA (US)

(21) Appl. No.: 14/498,583

(22) Filed: Sep. 26, 2014

(51) Int. Cl. G06Q 10/08; G06Q 30/06

(52) U.S. Cl. CPC G06Q 10/087; G06Q 30/0635

(57) ABSTRACT

The present invention relates to an automated inventory and ordering system. The invention determines inventory needs (by item) based on historical usage of each item to predict how much of each inventory item is needed for a future period of time.

### BACKGROUND OF THE INVENTIVE FIELD

The present invention is directed to the hospitality industry, and more particularly, to restaurant/bar inventory and ordering processing. More particularly, to a fully automated processor that is capable of customizing inventory ordering to the needs of each customer, including orders for particular sales budgets generated for a particular timeframe.

The process of inventory and ordering is a significant part of the business activities of hospitality companies. Efficient processing of inventory, ordering, and receiving not only minimizes labor cost, but also regulates over spending and waste. In addition, customers benefit by ensuring that their favorite establishments are adequately stocked with products. In the past companies have used manual processes as they do not fully understand the benefits provided by more efficient ordering processes. Recently however, with increased pricing of food and beverage, it is becoming more crucial for companies to tighten control over this process.

In general the inventory and ordering process can be grouped into four main processes—inventory taking, budgeting, ordering, and receiving. In addition, for greater control over cost, businesses may also look to loss variance reports and financial statements help identify problem areas.

### SUMMARY OF THE GENERAL INVENTIVE CONCEPT

The present invention provides a novel process for predicting inventory needs and for automatically preparing orders based on those calculated needs. The present invention determines inventory needs (by item) based on historical usage of each item to predict how much of each inventory item is needed for a future period of time. In the preferred embodiment, the system uses the ratio of historical sales over a certain period of time to the usage of each inventory item and applies it to predicted sales (for a future period of time) to determine how much of each inventory item to order. More specifically, in the preferred embodiment, predicted future sales for each item is determined based on historical sales data from the same period of time from the previous year. Year to year trends in sales may be taken into consideration to adjust the predicted sales data accordingly. Other data may also be taken into consideration to predict future sales such as historical and future weather conditions during the relevant time period the orders are to be placed for. In another embodiment, the system can be configured with a cushion allocation which increases the items ordered by a certain percentage (e.g. 15%) to ensure that there will be adequate inventory (i.e., padding of inventory). Additionally the system checks how the user prefers to purchase the items (e.g., case of 12 or case of 6), or if the user has multiple ways of ordering an item. The present invention may also include additional novel features such as providing alerts to the user, automatic integration with the point-of-sale (POS) system 98, checks for possible theft or misuse of inventory by using a loss variance feature, and the automatic running of financial statements.

The foregoing and other features and advantages of the present invention will be apparent from the following more detailed description of the particular embodiments, as illustrated in the accompanying drawings.

### BRIEF DESCRIPTION OF THE DRAWINGS

The following detailed description of the example embodiments refers to the accompanying figures that form a part thereof. The detailed description provides explanations by way of exemplary embodiments. It is to be understood that other embodiments may be used having mechanical and electrical changes that incorporate the scope of the present invention without departing from the spirit of the invention.

In addition to the features mentioned above, other aspects of the present invention will be readily apparent from the following descriptions of the drawings and exemplary embodiments, wherein like reference numerals across the several views refer to identical or equivalent features, and wherein:

FIG. 1 describes the process flow of the preferred embodiment of the invention;

FIG. 2 describes the process flow for the inventory process of the preferred embodiment of the present invention;

FIG. 3 describes the process flow for predicting budget in the preferred embodiment of the invention;

FIG. 4 describes the process flow for creating automated orders using the predictive ordering algorithm of the preferred embodiment of the present invention;

FIG. 5 describes the process flow of the variance algorithm of the preferred embodiment of the present invention; and

FIG. 6 describes one embodiment of the system components of the present invention.

### DETAILED DESCRIPTION OF EXEMPLARY EMBODIMENT(S)

The present invention provides an automated process for taking inventory, budgeting, ordering, and receiving. The novel process adapts to the business rather than the business trying to adapt to the process. In addition, it provides an automated ordering process that provides an accurate order based on budget considerations and inventory data

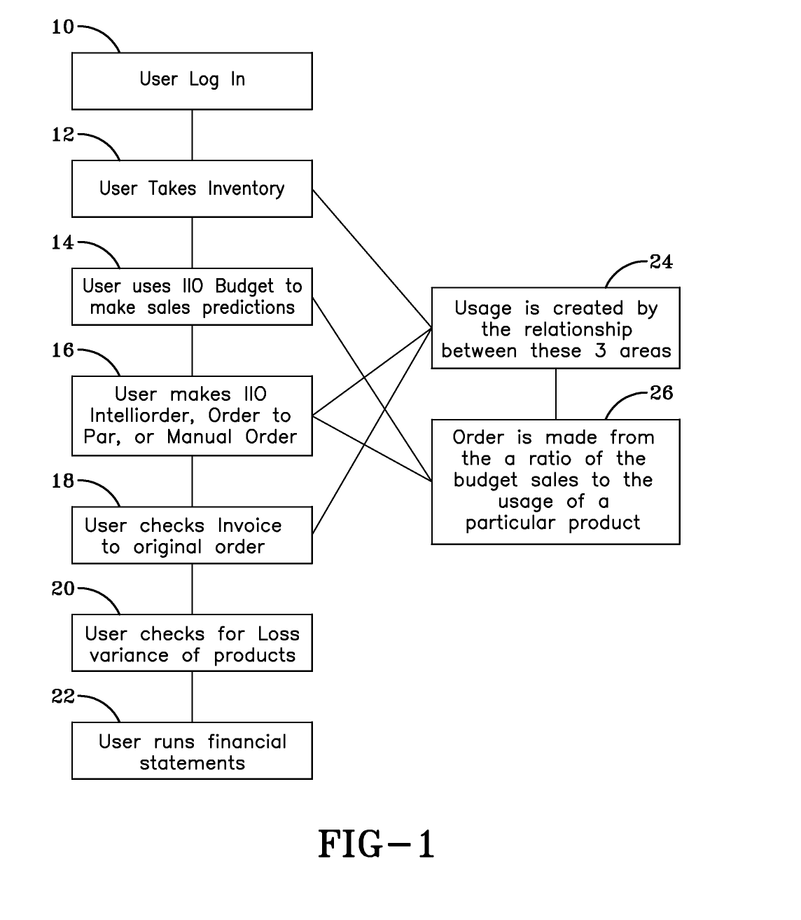

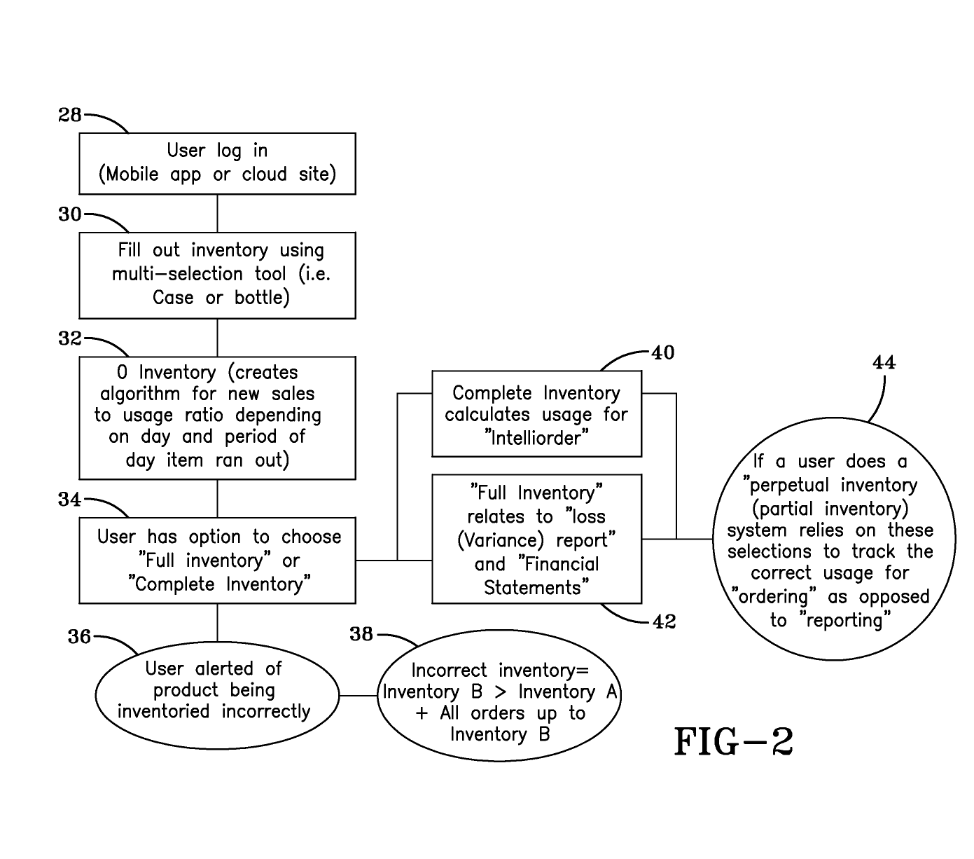

FIG. 1 describes the process flow of the preferred embodiment of the invention. Shows the exemplary process where the usage to sales ratio is used to determine the automated order. The present invention determines inventory needs (by item) based on historical usage of each item to predict how much of each inventory item is needed for a future period of time. In the preferred embodiment, the system uses the ratio of item usage over total sales over a certain historical period of time and then applies it to predicted sales (for a future period of time) to determine how much of each inventory item to order. In other words, in the preferred embodiment, the predicted future amount of the item needed per total business sales is calculated in proportion to historical usage of that item over total sales over a certain period of time. For more accurate predictions, the system preferably uses multiple “data points” of the usage to sales ratios to arrive at an average.

In the preferred embodiment of the invention, the user logs into the computer system 10. The user takes an inventory of items and inputs the current inventory into the computer system 12. The inventory can be taken manually from a printed sheet or from the custom made mobile application. The details of the inventory process according to one embodiment of the present invention is illustrated in FIG. 2.

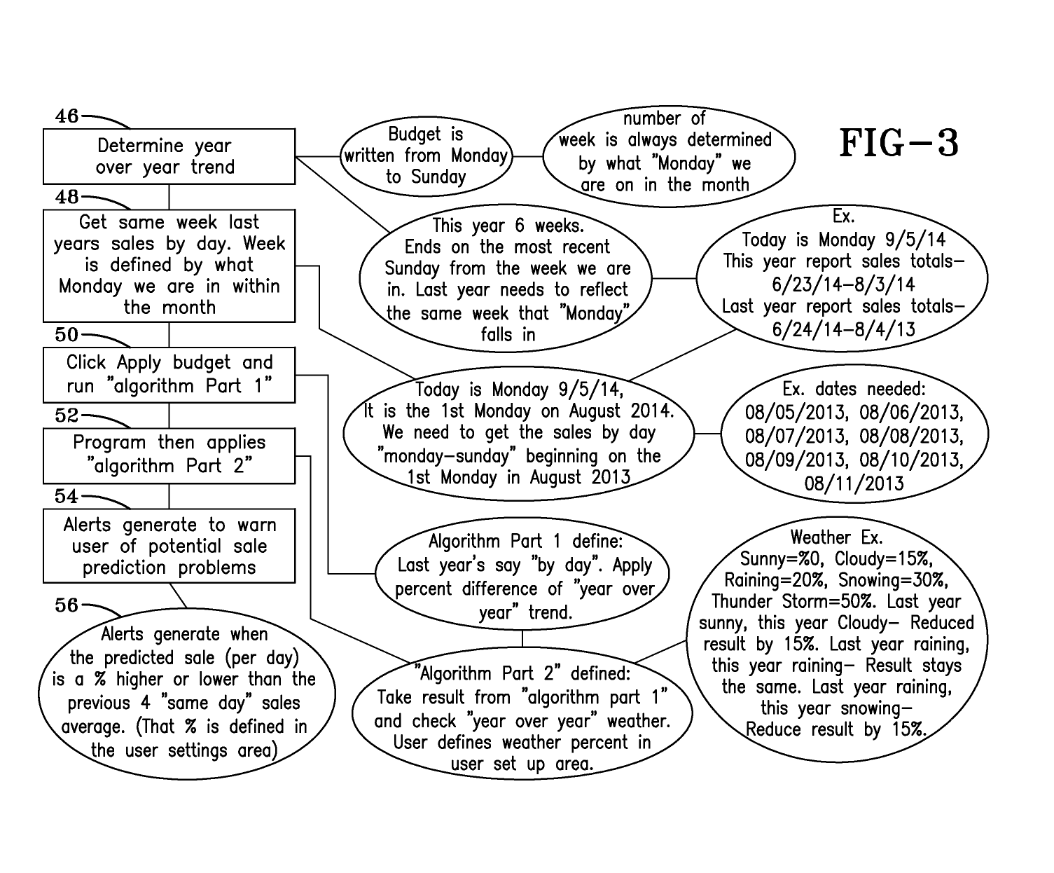

After taking inventory, the system may be used to prepare budget or sales predictions for a future period of time 14. The details of the sales prediction process according to one embodiment of the present invention is illustrated in FIG. 3. The system preferably uses historical sales numbers and year over year sales trends to predict the amount of sales for a future period of time (e.g. the next week, Monday through Sunday). The system may also be configured to take other factors into consideration in predicting sales, for example historical weather and future weather forecasts.

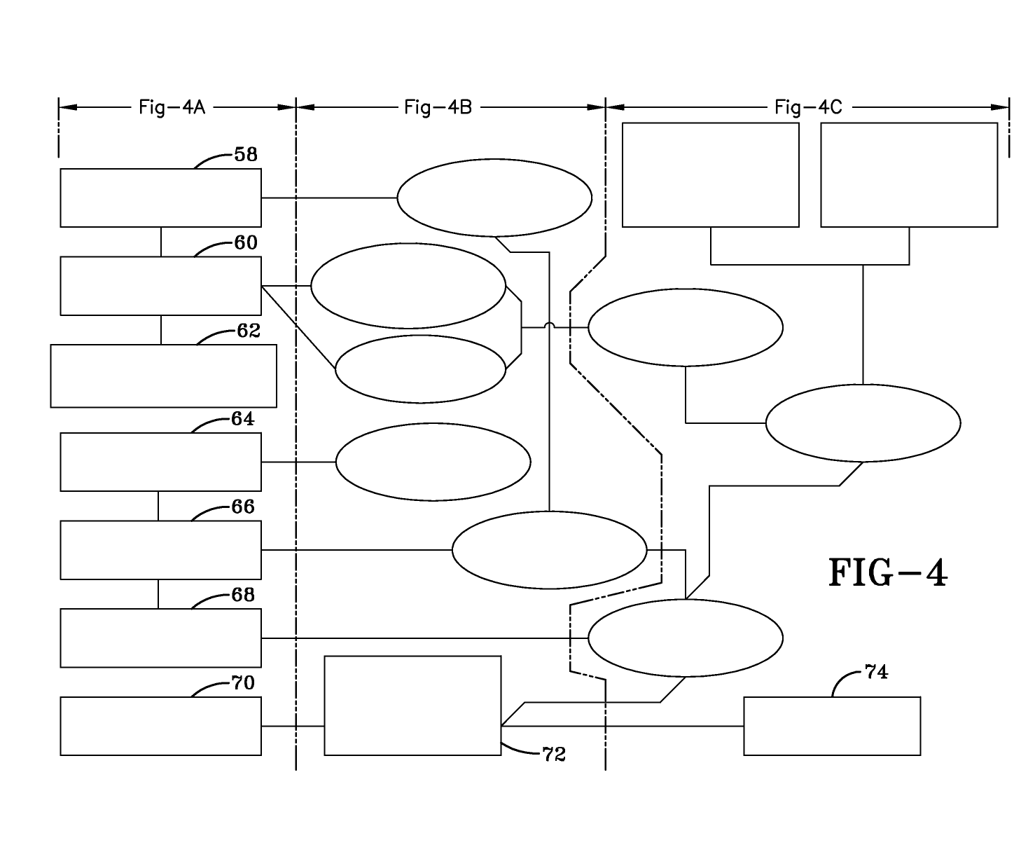

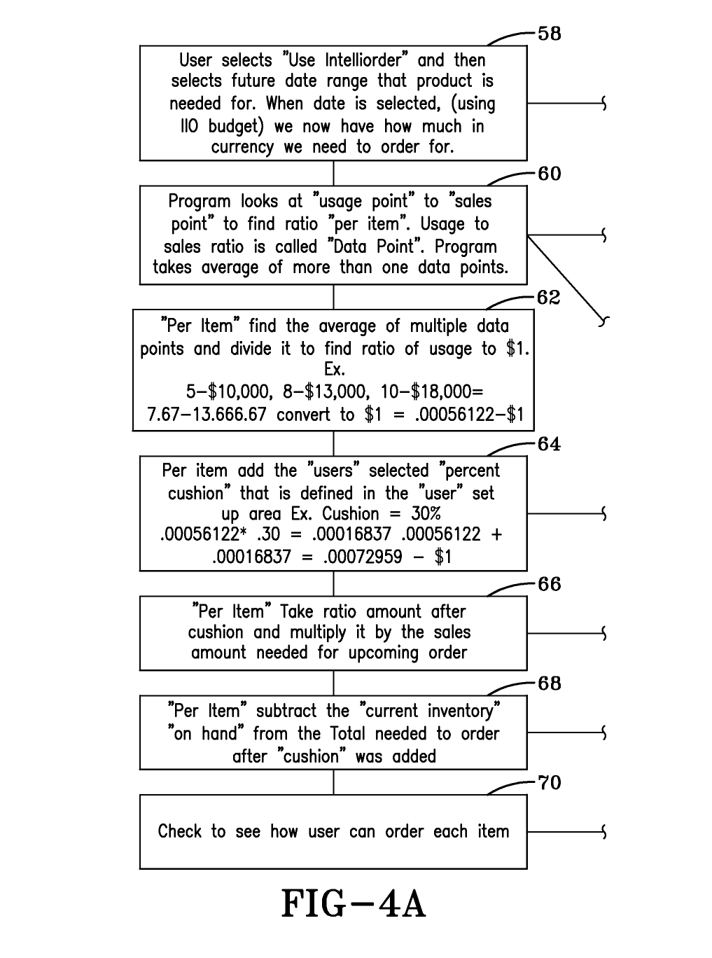

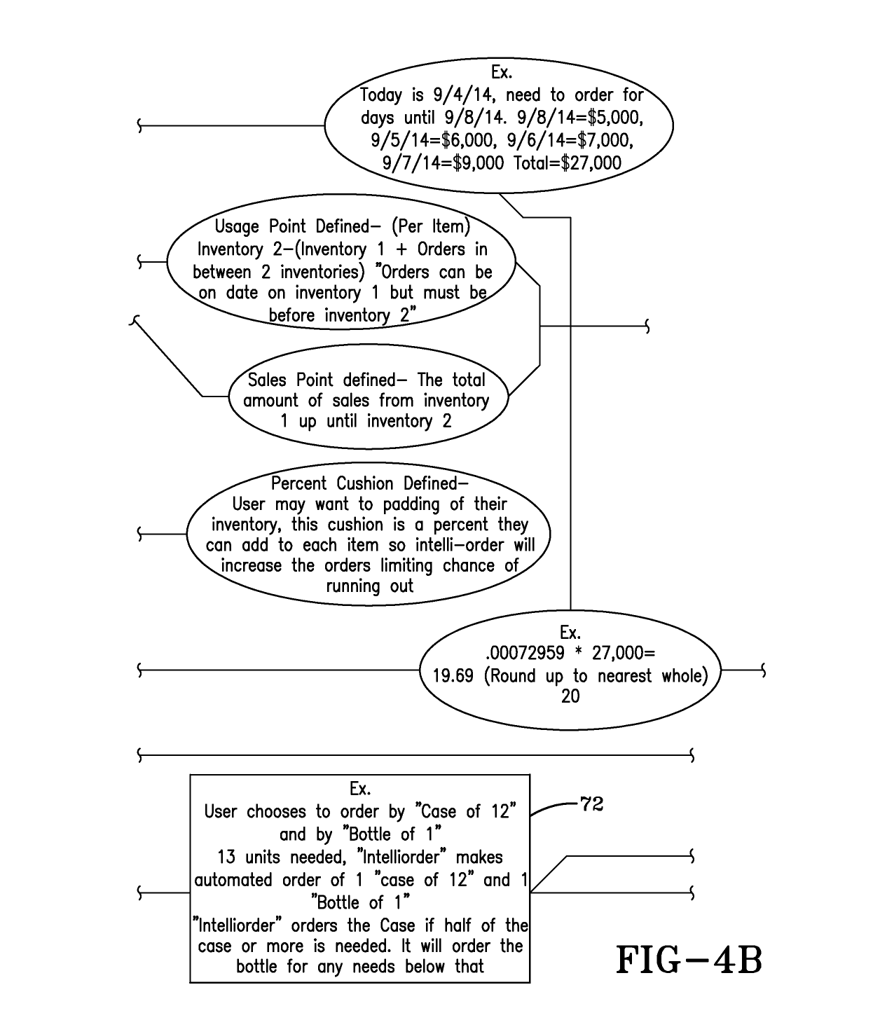

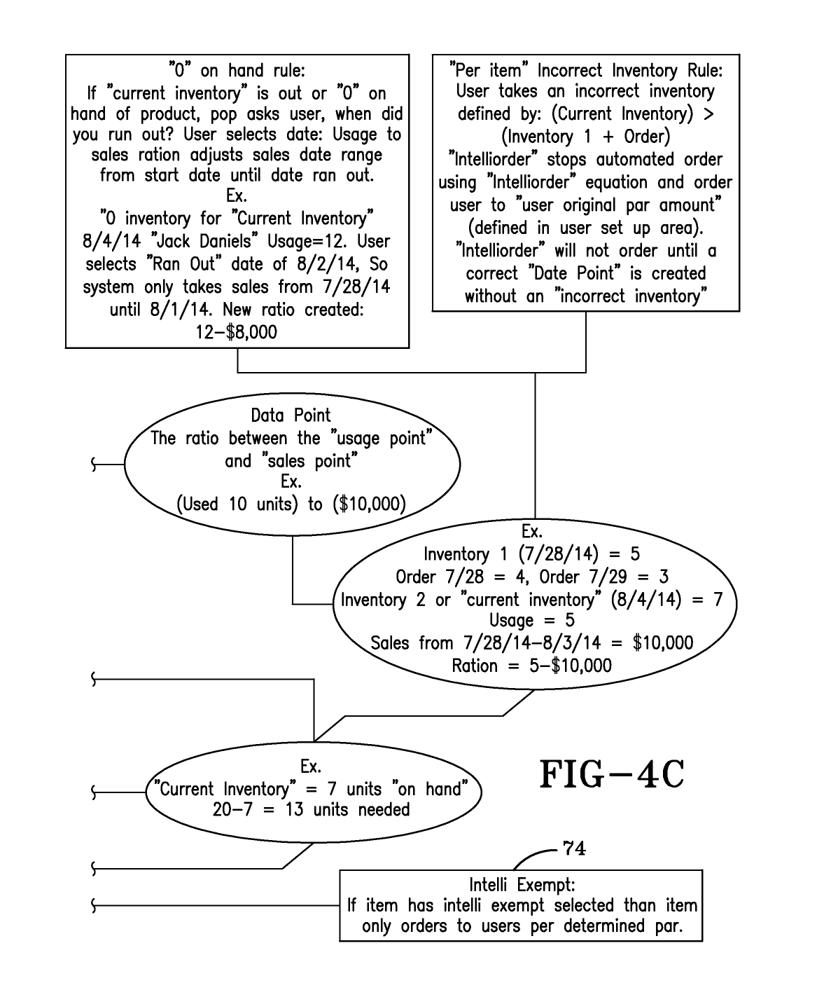

After predicting sales, the system can automatically prepare an order for inventory items 16. The details of the ordering process according to one embodiment of the present invention is illustrated in FIG. 4. As described in detail below, the order for each inventory item is prepared from using the ratio of historical budget data over a period of time to historical usage data for each inventory item over that period of time 26. “Usage” is the amount of inventory product used over a period of time, e.g., the time between taking inventories.

In one embodiment of the present invention, the system creates usage data for each inventory item based on the inventory data, sales prediction data, and invoice data 24. For example, the “invoice” data automatically updates the usage and purchase amounts for more accurate usage numbers. For instance if the order includes 12 bottles of vodka but only 6 was received, a user taking advantage of the “invoicing” part of the system can account for this mistake.

The user can checks the automated order with a printed order form against what is actually delivered by the vendors 18. Using the invoice, the user can check for discrepancies in product types and amounts received as well as costs of those products which can be automatically checked against core pricing. Automated credits can be created if the system detects a price discrepancy. The system can also be configured to automatically transmit emails to request refunds from the vendors.

Another tool provided by the system of the present invention is a variance report. If the user updates the system with actual data (“actuals”) versus projected data, this variance report should be 100% accurate. The user can choose to exclude any products he wishes to utilize the variance report for “big ticket” items, or the most popular items/most expensive items. For example, variance is the difference between the actual usage compared against the amount of what was actually sold. So if the system shows that 10 Grey Goose were sold but the system used 20, the variance is −10 (losses shown of 10 Grey Goose). Accordingly, the user is alerted that loss is occurring from theft or over pouring.

In another embodiment, when the system detects a cost percent increase the system can alert the user. Based on the process of the present invention, the user knows that the cost is not coming from an ordering overage. The user can check the loss variance report created by the system to see what items are being stolen or misused 20. Errors by the user in taking inventory can also be checked.

Financial reporting for cost percentage spends, and profits can be created by week, month, quarter, and year 22. The system can also prepare reports on how much money is being spent on products to determine if products are becoming less popular so they can be replaced with another product. For example a financial report can be prepared on what was bought and sold. Another example report is a profit or loss statement. In one embodiment an expense report can be prepared by the system (the starting inventory on hand) plus (all orders in between the two reporting inventory dates) minus (ending inventory on hand). The system can then prepare a cost percent report by taking the expense amount and divide by sales.

FIG. 2 describes the process flow for the inventory process of the preferred embodiment of the present invention. In one embodiment of the invention, the system includes a mobile inventory application. To take inventory, the user logs into the system 28, preferably using a login name and password. The application allows a user to drag and drop inventory to match the location of the inventory in the shelving system of their business. For example, the system can be configured to list out the inventory items within a location heading. This allows the user to reorganize the order by dragging and dropping the inventory line items into an order that will match their shelving on the wall.

The invention also provides a tool where users can track inventory by different unit types 30. This process speeds up the inventory-taking process and saves time. For example, bottle beer can be tracked by cases or individual beers. The system allows the user to make a budget or a prediction of future sales using the present system 32.

In one embodiment of the invention, the system provides the option to take a “full” inventory or a “complete inventory” 34. For example, a “full” inventory is used for “financial reporting” and “loss statements”. The purpose of this is to separate the “inventory for ordering” purposes as opposed to the “inventory for reporting” purposes. The system preferably uses a “complete” inventory for calculating usage of inventory products 40, 42. Many restaurants don't have time to take inventory of every single product for every location in the restaurant so for usage tracking for ordering purposes the system allows the business to take a partial inventory, e.g., inventory the “cooler” but not the “cook line”. If a user does a “perpetual” inventory (partial inventory), the system relies on these selections to track the correct usage for ordering as opposed to reporting 44. The system can prepare financial reports for the business using a “full/end of month inventory”. This gives the business the “amount on hand in $ for product”. This is important because just because a business purchases something doesn't mean that the business does not still have that money in product. The system accounts for that and gives a financial report to include this money on hand. In order to make a financial report accurate, the system takes (“Starting Full inventory amount on hand in $$”+“all ordering in $$”)−(Ending full inventory amount on hand in $$).

In the preferred embodiment of the invention, the system provides an alert to the user if the system detects that a product is being inventoried incorrectly 36, 38. For example, if the inventory being taken for any product is greater than the inventory taken on a past day (including any intervening orders of the product), then the system knows that an error has occurred.

FIG. 3 describes the process flow for predicting budget or future sales in the preferred embodiment of the invention. A calendar may be displayed by the system highlighting dates in red to determine what sales the user needs to ready the budget or predicted sales data. For example, highlighted “red” sales dates in the calendar alerts the user to notify the user that “actual” sales data for those dates have not been entered or uploaded. The system helps the user to see what sales days need to be updated in order to allow the system prepare the order. The historical sales data is used by the system of the present invention to calculate the order needed for a future period of time. In one embodiment of the invention, the system allows the user to click the sale date on the calendar, which causes the system to load the sales data as a CSV file from the POS device.

In the preferred embodiment of the invention, the system determines the year over year trend in sales to factor into the determination of future sales 46. For example, the system may look at the past “6 weeks time period” and the same “6 weeks period from last year to determine the year over year trend. For example, taking the percentage difference provides a picture of how the business is trending year over year . . . As an example, the total sales for the past 6 weeks last year is $500,000 (e.g., budget written for Mon-Sun) and the total sales for the past 6 weeks this year is $250,000 (Mon-Sun). Taking the percentage difference between the two let's the business owner know that sales are trending down approximately 50% year over year. This percentage difference can be applied to last year's historical sales numbers (per time period, e.g., day) to calculate the predicted sales for the same time period this year.

So continuing with the above example, using the year over year trend, if:

Sales for a particular Monday last year=$10,000

Projections for the corresponding Monday of this year would be $5,000.

In other words, the year over year trend data would be applied to last year's sales by day to get the predicted sales for the same day this year 48, 50. This type of calculation can be done for all of the days in the time period orders are being prepared for to get the total predicted sales number.

Other factors can also be applied to fine tune the sales prediction. For example, historical and future weather conditions can be factored in 52. For example, if last year, the particular day was sunny, but the weather forecast for this year is cloudy, the predicted sales number can be reduced by 15% (assuming that generally, the business sees a 15% reduction in sales on a cloudy day compared to a sunny day). Similarly, the predicted sales number can be increased, for example, if last year, a particular day was rainy, but this year the forecast is for a sunny day. The user can define any of these percentages in a user “set-up” area of the application.

As an example of the sales prediction process of the present invention, assume today's date is Monday Aug. 25, 2014. The system will automatically ask for the most recent six weeks sales number (e.g., Monday through Sunday—Jul. 14, 2014-Aug. 24, 2014). Then it will find the sales number for the same corresponding six weeks from the previous year (e.g., the six weeks prior to the corresponding “Monday of the month” from last year (2013)) (e.g., .Jul. 15, 2013-Aug. 25, 2013). Assuming that the sales for these two six year periods are:

Jul. 14, 2014-Aug. 24, 2014=$545,257.68

Jul. 15, 2013-Aug. 25, 2013=$539,151.16

The system will calculate the percent difference year over year in to determine that year over year sales are down approximately 1.13%. This year over year sales trend data is applied to the historical sales numbers (e.g., per day) to calculate predicted sales. As described above, in the preferred embodiment, the system knows what “Monday” of the month it is. For example, if it is the fourth Monday of August, the system looks at what the date was on the fourth Monday of August the previous year to determine historical sales (for example, if that Monday was the 26^{th}, the system then knows that it must retrieve the sales for the six weeks prior to that Monday).

In one embodiment of the present invention, alerts may be generated by the system to warn users of potential problems in sales predictions 54. For example, alerts can be generated when the predicted sales (e.g., per day) is a % higher or lower than the previous four “same day” sales average (that % may be defined by the user in the “settings” menu option of the application). The system can also be configured to provide alerts to the user when predicted sales (per day) are higher or lower than the previous four “same day” sales average 56.

The system predicts sales by using the “percent difference year over year” and “weather” logic defined above. But, when one of those outcomes is different by more or less than 20% (defined by user set up) of the average of the most previous four “same day actual sales” then an alert will appear. “Same day” means if an alert happens on “Monday” then the system checks the past four “Mondays” for the average of those sales.

As an example, on Monday, the predicted sales are $20,000. The past four Mondays have a sales average of $10,000. Since $20,000 is 20% more or less than $10,000, the system will provide an alert. This anomaly may have occurred because of a special event that took place on the corresponding Monday of last year (e.g., 4^{th} of July) that caused the prediction to by high. The system alerts help the user from making budget mistakes when an anomaly happens and to ensure that the predicted sales and order is accurate as possible. In this case, the user can manually adjust the order if the user determines that there is problem with the predicted sales number.

FIG. 4 describes the process flow for creating automated orders using the predictive ordering algorithm of the preferred embodiment of the present invention. The user opens up the application on the computer system and selects a future date range a particular product or products are needed for 58. For example, if today's date is Sep. 4, 2014, the user may need to order for the days up until Sep. 8, 2014. In the example of FIG. 4, the system uses the predictive budgeting process of the present invention to determine that future sales for this time period are $27,000.

The system then determines the orders for each inventory item based on historical usage of each item. The system predicts how much of each inventory item is needed for a future period of time by applying historical usage of each item.

Specifically this is done (for each inventory item) by taking the ratio of historical sales ($) over a certain period to the usage of each item over that period and applying it to predicted future sales (for a future period of time) to determine how much of each item to order 60, 62, 64, 66, 68. As discussed in detail above, predicted future sales is determined based on historical sales of the same period from previous year(s) and other data such as weather forecast. In one embodiment, the weather forecast preferably factors into the final budget so it is generally not needed here as the weather forecast has already been applied to determine the “sales projection” needed.

In the preferred embodiment, the amount of each inventory item to order is calculated by taking the “data point” 60 for each inventory item (the ratio between the “usage point” and “sales point” for each item over a historical period of time) and applying it to the predicted sales for the same item 66 to determine the amount of the inventory item needed. The amount of each inventory item needed is reduced by the amount of the item currently in inventory to determine the number of units or amount of each item to order 68. As previously discussed, the system can be configure to allow the user to choose how to order each item (e.g., by case, unit, etc.) 70, 72. The system also allows users to exempt selected items 74. For example, if a user selects (in the account setting menu option) a box called “intelli exempt” for a particular inventory item, that item is exempt from the system's ordering logic. In such a case, the system will only order to a predetermine par-level defined by the user at the initial set up. This is important for items that have no usage that correlates with sales (e.g., air fresheners). These types are items are changed within a particular amount of time as opposed to a particular amount of sales.

The “usage point” for each item is calculated by using the formula (Inventory 2−(Inventory 1+Orders in between 2 Inventories)−where Inventory 2 is simply the 2nd inventory the user took and Inventory 1 represents the 1^{st} inventory taken by the user. So, in other words, the user takes the 1st inventory, and makes an order. Now the user needs to order more so he takes a “2nd” inventory and prepares a second order.

As an example:

Grey Goose Inventory 1 on Aug. 25, 2014=10

Grey Goose Orders in-between inventories=5

Grey Goose Inventory 2 on Aug. 27, 2014=3

Usage over the time period between Inventories 1 and 2=3−(10+5) or −12. The negative symbol is removed to obtain the usage of Grey Goose for the time period between the two Inventories is 12 (e.g., 12 bottles of Grey Goose used).

The “sales point” is defined as the total amount of sales of the business between the Inventories used to determine the usage point per item (preferably including the day of the first inventory but not including the day of second inventory). Accordingly, data point for each inventory item can be calculated with the usage point per item and the corresponding sales point. The average of multiple data points can be used to find a ratio to $1 62. A sales “cushion” can be applied to order a certain % amount over the calculated need so that the system can order extra of each item to ensure that each item will be in stock 64.

As an example:

Assume that the sales total from all of the inventory products from Aug. 25, 2014 to Aug. 26, 2014 (sales days up to but not including 2nd inventory date sales)=$10,000.

Assume historical usage of Grey Goose over that period is 12.

Grey Goose data point for ordering=12 to $10,000 or (0.0012 of Grey Goose to $1).

Apply a cushion defined by user: 30%=(0.00156 to $1).

Our sales projections for the future period in which the order is being prepared for (in $) is $ 40,000.

$40,000*0.00156=62.4 Grey Goose needed based on the usage to sales ratio or “data point”.

Subtract 62 by the current inventory to determine the amount of Grey Goose to order.

When there are many data points the system can be configure to take the average of multiple data points. For example, usage points can be calculated and stored for many intervals of time:

Inventory 1=(10 Grey Goose)

(Order=5)

Inventory 2=(3)

Usage=(12) “From Inventory 1 to Inventory 2”

(Order=6)

Inventory 3=(4)

Usage=(5) “From inventory 2 to inventory 3”

(Order=3)

Inventory 4=(2)

Usage=(5) “From inventory 3 to inventory 4)

(Order=6)

Inventory 5=(2)

Usage=(6) “From inventory 4 to inventory 5)

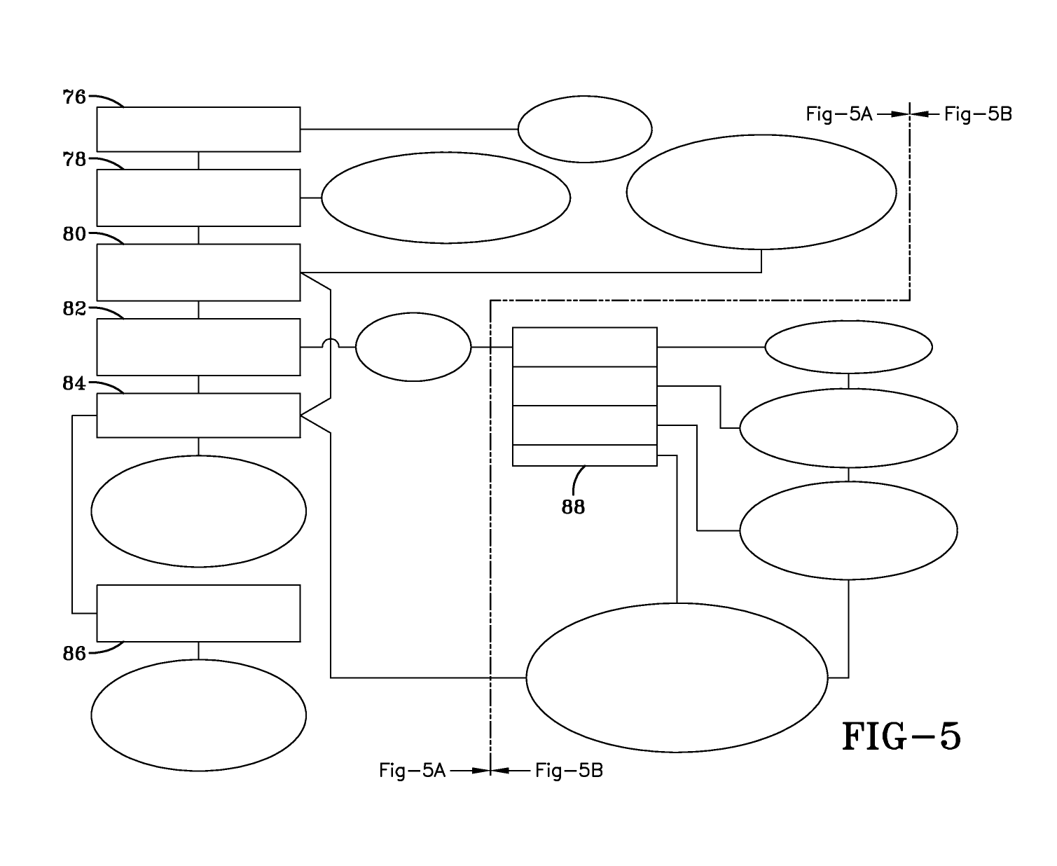

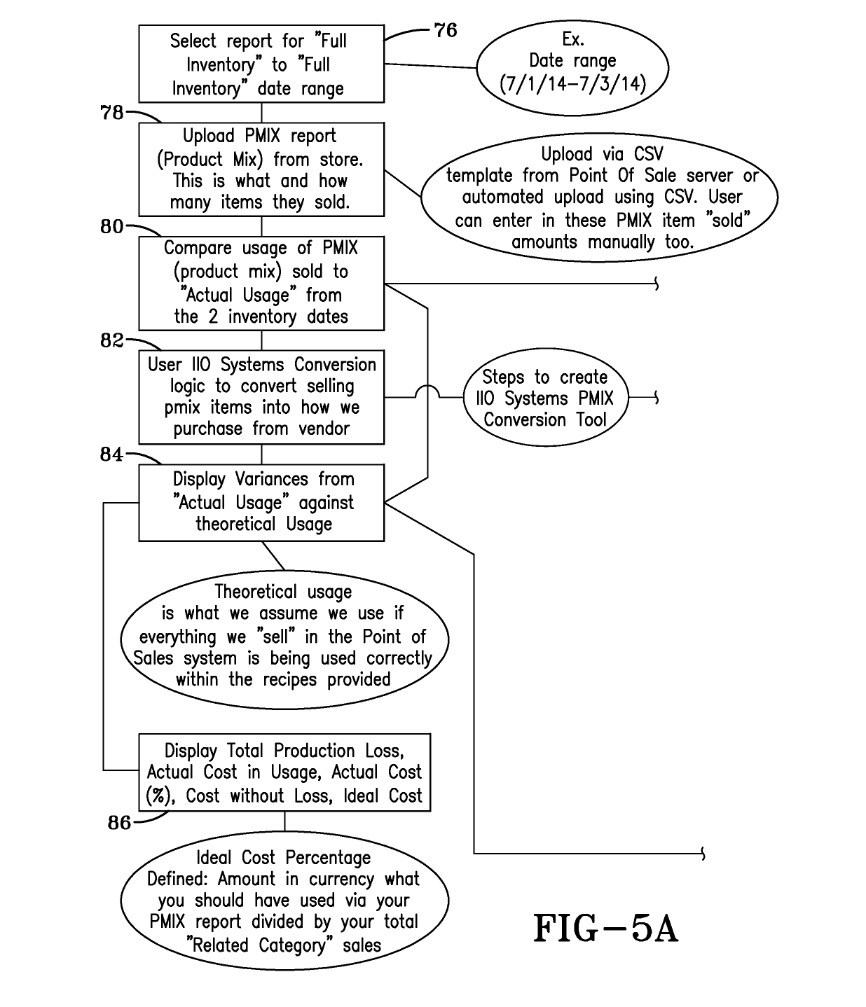

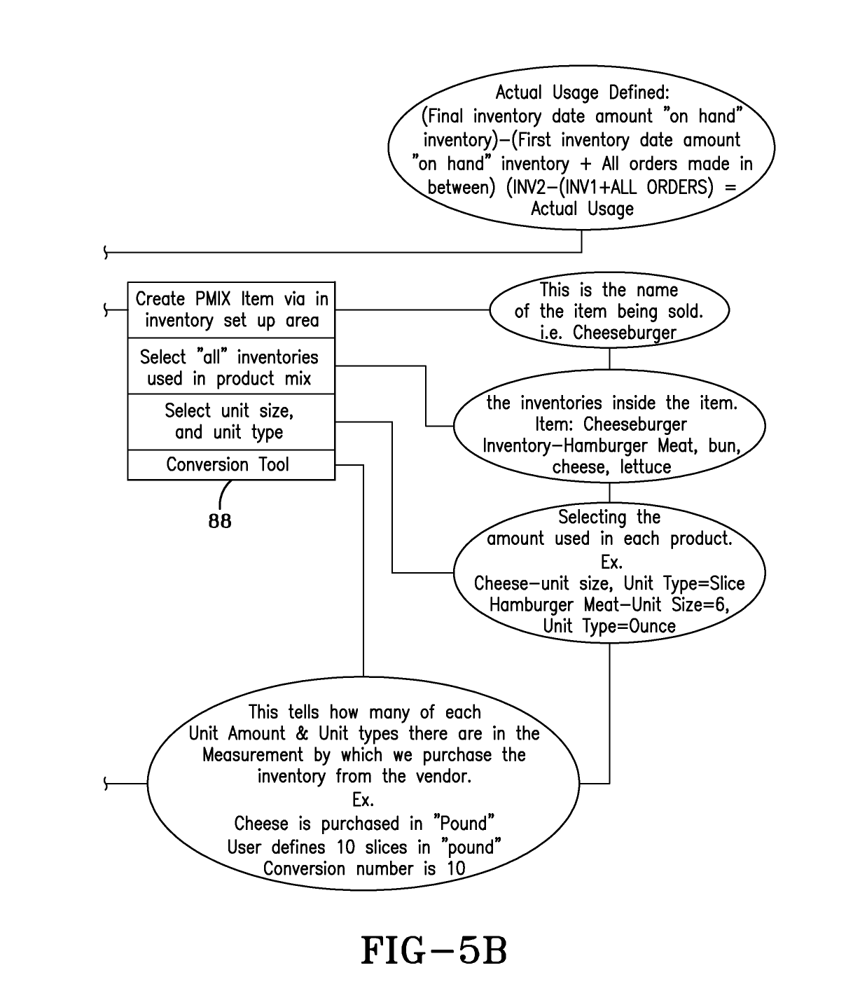

FIG. 5 describes the process flow of the variance algorithm of the preferred embodiment of the presentation invention. In the preferred embodiment, the user selects a “full or end of month” inventory to run a loss report 76. This is necessary because the report would not be accurate if a partial inventory was taken. There may be products in areas that have not been inventoried that would contribute against the loss statement 78. The user needs to upload what was sold from a product mix report via the POS system or enter what was sold manually into the inventory system 78. The invention will compare the usage already collected within the system against the amount sold as provided by what the user uploaded from the POS. For instance, if the POS shows the user has sold 20 “Grey Goose Shots” at 1 ounce used for each sale, the total ounces sold is 20 ounces. The system, through the use of inventories, may determine that within that same date range 30 ounces of Jack Daniels was used. The system therefore concludes there was 10 ounces of loss. The system will automatically convert this data back into how the user buys the inventory item (e.g., in “Liter” bottles, each Liter having 33.81 ounces, the system will calculate a loss of 0.30 Jack Daniels bottle). 78, 80. For benefit of the user, the system will convert the measurement details into how the user purchases the product from vendors 82, 84, 88. This will make for an easier read report 86 that defines how totals will be displayed for the user. Totals, percentages of loss, and an ideal cost/cost without loss can show the user what he could have done if he had not incurred the loss in products. Because the system knows the date range within these “loss reports” it can determine what the COGS or cost percentages associated with the usage and sales of the products in the loss statement and display it for the users for informational purposes. For example, if 2 bottles of Grey Goose were used that cost $30 each, but only 1 bottle was sold, and assuming $10,000 in sales: the invention will display the current cost percentage “with loss”, which equals 60/10,000 .(or 6%), and will also show the amount in dollars spent which was $60. The system can also be configured to show the user what could have happened if no loss had occurred. So they system will display the “cost without loss” which would be $30 and a cost percentage of 0.3%. This information allows the user to gain insight into how much money the business is using for no other reason than mismanagement or theft. To a manager, it gives perspective of the COGS %.

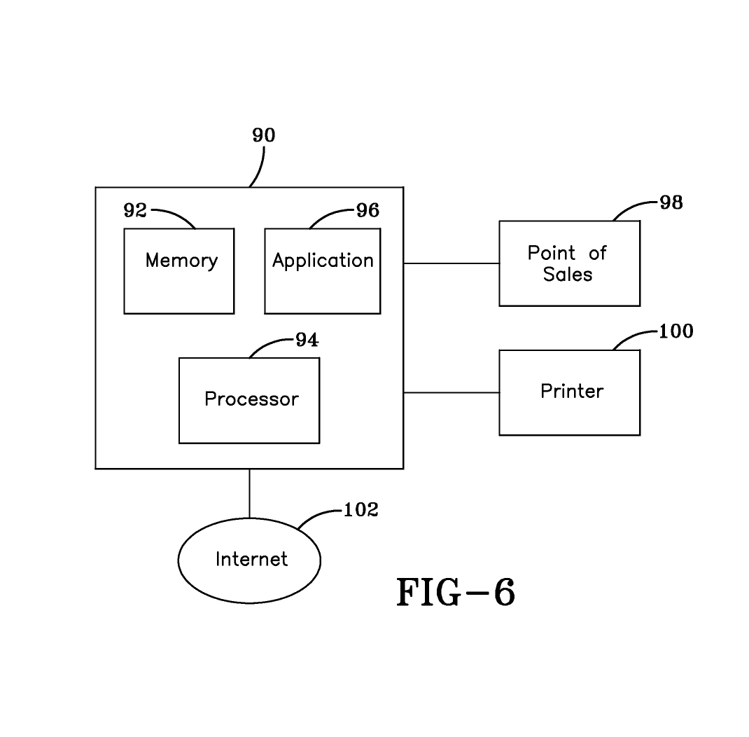

FIG. 6 describes one embodiment of the system components of the present invention. In one embodiment of the invention, the system components are comprised of a computer system 90, having a memory 92, processor 94, and an application 96 (such as a mobile application). The computer system having the application for running the process of the present invention is preferably connected to a point-of-sale (POS) system for communicating historical sales data to the application. In one embodiment, the data is communicated between the POS system and the computer system via CSV and API data links. The computer system may also be connected to a printer 100 and the Internet 102 for retrieving other data for running the process of the present invention. For example, the system can connect to the Internet for obtaining historical and future weather data. In one embodiment, the system connects to a cloud based system, configured for one hour back-ups of all data and history protection for all actions taken on the site.

While certain embodiments of the present invention are described in detail above, the scope of the invention is not to be considered limited by such disclosure, and modifications are possible without departing from the spirit of the invention as evidenced by the following claims:

What is claimed is:

1. A system for providing automated orders of inventory items for a business, comprising:
a computer processing system;
a memory device in communication with the computer processing system, the memory configured to store information, the information including historical usage data for a plurality of inventory items, historical sales data for the business;
wherein the computer processing system is programmed with one or more software routines executing on the computer processing system configured to:
a. determine the historical usage of a first inventory item;
b. determine how much of the first inventory item is needed for a future period of time;
c. prepare an order for the first inventory item.

2. A system according to claim 1, wherein the computer processing system is programmed with one or more software routines executing on the computer processing system configured to:
a. predict future sales of the business for the future period of time;
b. determine a ratio of the historical usage of the first inventory item to the historical sales data for the business over a past period of time; and
c. determine the amount of the first inventory item to order by applying the ratio to the future sales of the business for the future period of time;
d. automatically prepare an order with the amount of the first inventory item.

3. A system according to claim 2, wherein the computer processing system is programmed with one or more software routines executing on the computer processing system configured to
a. apply a year-over-year sales trend to adjust the determined future sales of the business for the future period of time.

4. A system according to claim 2, wherein the computer processing system is programmed with one or more software routines executing on the computer processing system configured to:
a. factor in a year-to-year weather trend to adjust the determined future sales of the business for the future period of time.

5. A system according to claim 2, wherein ratio is a “data point” and wherein the computer processing system is programmed with one or more software routines executing on the computer processing system configured to:
a. use the average of a plurality of data points for a plurality of timeframes to determine the amount of the first inventory item to order.

6. A system according to claim 2, wherein the computer processing system is programmed with one or more software routines executing on the computer processing system configured to:
a. increase the determined amount of the first inventory item to order by a predetermined percentage to ensure the first inventory item remains in stock of the future period of time.

7. A system according to claim 2, wherein the computer processing system is programmed with one or more software routines executing on the computer processing system configured to:
a. repeat steps a. through c. of claim 2 to the plurality of inventory items to determine the amount of the plurality of inventory items to order.

8. A system according to claim 2, wherein the computer processing system is programmed with one or more software routines executing on the computer processing system configured to:
a. determine the difference between actual usage of the first inventory item to the amount of the first inventory item sold;
b. prepare a variance report showing any losses of the first inventory.

9. A system according to claim 2, wherein the past period of time is the time between the last two inventories taken.

10. A system according to claim 3, wherein the year-over-year sales trend is determined by comparing sales over a six week period from the current year to sales over the same six week period from a previous year.

11. A system according to claim 1, wherein the future period of time is the upcoming week.

12. A system according to claim 1, wherein the computer processing system is programmed with one or more software routines executing on the computer processing system configured to
a. apply a year-over-year sales trend as factor in determining the amount of the first inventory item needed for a future period of time.

13. A system according to claim 1, wherein the computer processing system is programmed with one or more software routines executing on the computer processing system configured to:
a. apply a year-to-year weather trend as a factor in determining the amount of the first inventory item needed for a future period of time.

14. A system for providing automated orders of inventory items for a business, comprising:
a computer processing system;
a memory device in communication with the computer processing system, the memory configured to store information, the information including historical usage data for a plurality of inventory items, historical sales data for the business;
wherein the computer processing system is programmed with one or more software routines executing on the computer processing system configured to:
a. determine historical usage of a first inventory item;
b. predict future sales of the business for a future period of time;
c. determine a ratio of the historical usage of the first inventory item to the historical sales data for the business over a past period of time;
d. determine the amount of the first inventory item to order by applying the ratio to the predicted future sales of the business for the future period of time;
e. automatically prepare an order with the amount of the first inventory item.

15. A system according to claim 14, wherein the computer processing system is programmed with one or more software routines executing on the computer processing system configured to
a. apply a year-over-year sales trend to adjust the determined future sales of the business for the future period of time.

16. A system according to claim 14, wherein the computer processing system is programmed with one or more software routines executing on the computer processing system configured to:
a. factor in a year-to-year weather trend to adjust the determined future sales of the business for the future period of time.

17. A system according to claim 14, wherein ratio is a “data point” and wherein the computer processing system is programmed with one or more software routines executing on the computer processing system configured to:
a. use the average of a plurality of data points for a plurality of timeframes to determine the amount of the first inventory item to order.

18. A system according to claim 14, wherein the computer processing system is programmed with one or more software routines executing on the computer processing system configured to:
a. increase the determined amount of the first inventory item to order by a predetermined percentage to ensure the first inventory item remains in stock of the future period of time.

19. A method for providing automated orders of inventory items for a business, comprising the steps of:
storing information, the information including historical usage data for a plurality of inventory items, historical sales data for the business;
obtaining historical usage of a first inventory item;
predicting future sales of the business for a future period of time;
determining a ratio of the historical usage of the first inventory item to the historical sales data for the business over a past period of time;
determining the amount of the first inventory item to order by applying the ratio to the predicted future sales of the business for the future period of time;
automatically preparing an order with the amount of the first inventory item.

20. A method according to claim 19, further comprising the step of applying a year-over-year sales trend to adjust the determined future sales of the business for the future period of time.

21. A method according to claim 19, further comprising the step of factoring in a year-to-year weather trend to adjust the determined future sales of the business for the future period of time.

22. A method according to claim 19, wherein ratio is a “data point” and wherein the method is further comprised of the step of using the average of a plurality of data points for a plurality of timeframes to determine the amount of the first inventory item to order.

23. A method according to claim 19, further comprising the step of increasing the determined amount of the first inventory item to order by a predetermined percentage to ensure the first inventory item remains in stock of the future period of time.
